(19) United States
(12) Patent Application Publication
(10) Pub. No.: US 2011/0252184 A1
(43) Pub. Date: Oct. 13, 2011

(54) METHOD OF STORING DATA IN STORAGE MEDIA, DATA STORAGE DEVICE USING THE SAME, AND SYSTEM INCLUDING THE SAME

(75) Inventors: Kyoung Lae CHO, Yongin-si (KR); Donggi LEE, Yongin-si (KR); Hee Chang CHO, Seoul (KR); Bumseok YU, Suwon-si (KR); Junjin KONG, Yongin-si (KR); Hyungjoon PARK, Yongin-si (KR)

(73) Assignee: Samsung Electronics Co., Ltd., Suwon-si (KR)

(21) Appl. No.: 13/082,721

(22) Filed: Apr. 8, 2011

(30) Foreign Application Priority Data
Apr. 9, 2010 (KR) 10-2010-0032803

(51) Int. Cl. G06F 12/02

(52) U.S. Cl. 711/102; 711/E12.007

(57) ABSTRACT

A method of storing data in a storage media is provided which includes sequentially compressing data by a compression unit, and storing the compressed data in the storage media, the compression unit being varied according to a compression characteristic of data to be stored in the storage media.

### CROSS-REFERENCE TO RELATED APPLICATIONS

This application claims priority under 35 U.S.C. §119(a) from Korean Patent Application No. 10-2010-0032803, filed on Apr. 9, 2010 in the Korean Intellectual Property Office, the entirety of the disclosure of which is incorporated by reference herein.

### BACKGROUND

1. Field of the Invention

The present general inventive concept relates to electronic devices, and more particularly, the present general inventive concept relates to a data storage device.

2. Description of the Related Art

As it is known in the art, computer systems generally use several types of memory systems. For example, computer systems generally use so-called main memory comprised of semiconductor devices typically having the attribute that the devices can be randomly written to and read from with comparable and very fast access times and thus are commonly referred to as random access memories. However, since semiconductor memories are relatively expensive, other higher density and lower cost memories are often used. For example, other memory systems include magnetic disk storage systems. In case of magnetic disk storage systems, generally, access times are in the order of tens of milliseconds. On the other hand, in the case of main memory, the access times are in the order of hundreds of nanoseconds. Disk storage is used to store large quantities of data which can be sequentially read into main memory as needed. Another type of disk-like storage is solid state disk storage (SSD, also called solid state drive). SSD is a data storage device that uses memory chips, such as SDRAM (Synchronous Dynamic Random Access Memory), to store data, instead of the spinning platters found in conventional hard disk drives.

The term “SSD” is used for two different kinds of products. The first type of SSD, based on fast, volatile memory such as SDRAM, is categorized by extremely fast data access and is used primarily to accelerate applications that are held back by the latency of disk drives. Since this SSD uses volatile memory, it typically incorporates internal battery and backup disk systems to ensure data persistence. If power is lost for whatever reason, the battery keeps the unit powered long enough to copy all data from RAM to backup disk. Upon the restoration of power, data is copied back from backup disk to RAM and the SSD resumes normal operation. The first type of SSD is especially useful on a computer which is already has the maximum amount of RAM. The second type of SSD uses flash memory to store data and is generally used to replacement of a hard disk drive.

### SUMMARY

Exemplary embodiments of the present general inventive concept can provide a method of storing data in a storage media. The method includes sequentially compressing data by a compression unit, and storing the compressed data in the storage media, the compression unit being varied according to a compression characteristic of data to be stored in the storage media.

Additional features and utilities of the present general inventive concept will be set forth in part in the description which follows and, in part, will be obvious from the description, or may be learned by practice of the present general inventive concept.

Exemplary embodiments of the present general inventive concept may also provide a data storage device which includes a storage media, and a controller to compress data to be stored in the storage media by a compression unit, the controller to control the compression unit so that a size of compressed data is fitted to a physical storage unit of the storage media.

Exemplary embodiments of the present general inventive concept may also provide a system having a plurality of solid state drives, where each of the plurality of solid state drives includes a storage media, and a controller to compress data to be stored in the storage media, the controller to compress data to be stored in the storage media by a compression unit and to control the compression unit variably according to a compression characteristic of data to be stored so as to constantly maintain a size of data compressed by the compression unit.

Exemplary embodiments of the present general inventive concept may also provide a method of storing data in a storage apparatus, the method including compressing data with a controller of the storage apparatus by varying the compression according to at least one characteristic of the data, and storing the variably compressed data in a storage apparatus communicatively connected to the controller.

The varying the compression may include adjusting a size of a unit of compression.

The compressing of the data may include determining at least one unit of compression with the controller, dividing the data into one or more sub-groups according the to the determined at least one unit of compression, and compressing the data according to the at least one unit of compression.

Exemplary embodiments of the present general inventive concept may also include a data storage apparatus including a storage media, and a controller to compress data by varying the compression according to at least one characteristic of the data and to store the variably compressed data in the storage media communicatively connected to the controller.

The data storage apparatus may include where the controller adjusts a size of a unit of compression.

The data storage apparatus may include where the controller determines at least one unit of compression, divides the data into one or more sub-groups according to the determined at least one unit of compression, and compresses the data according to the at least one unit of compression.

The data may include a first unit of data and a second unit of data, and the controller may compress the first unit of data according to a first characteristic of the data and may compress the second unit of data according to a second characteristic of the data.

### BRIEF DESCRIPTION OF THE DRAWINGS

The above and/or other aspects of the present general inventive concept will become apparent and more readily appreciated from the following description of the exemplary embodiments, taken in conjunction with the accompanying drawings, in which:

FIG. 1 is a block diagram illustrating a data storage device according to exemplary embodiments of the present general inventive concept;

FIG. 2 is a block diagram illustrating the controller of FIG. 1 according to exemplary embodiments of the present general inventive concept;

FIG. 3 is a flow chart illustrating a write operation of a data storage device according to exemplary embodiments of the present general inventive concept;

FIG. 4 is a diagram illustrating a division unit varied according to attributes of stream data provided to a data storage device according to exemplary embodiments of the present general inventive concept;

FIG. 5 is a block diagram illustrating the controller of FIG. 1 according to exemplary embodiments of the present general inventive concept;

FIG. 6 is a flow chart illustrating a write operation of a data storage device according to exemplary embodiments of the present general inventive concept;

FIG. 7 illustrates a write flow of a data storage device according to exemplary embodiments of the present general inventive concept;

FIG. 8 is a block diagram illustrating a data storage device according to exemplary embodiments of the present general inventive concept;

FIGS. 9 and 10 are block diagrams illustrating systems including a data storage device according to exemplary embodiments of the present general inventive concept;

FIG. 11 is a diagram illustrating a log mapping that can be applied to a data storage device according to exemplary embodiments of the present general inventive concept;

FIG. 12 is a diagram illustrating tables managed by a memory translation layer (MTL) applied to a data storage device according to exemplary embodiments of the present general inventive concept;

FIG. 13 is a diagram illustrating an assignment of log blocks conducted when a write operation is performed according to exemplary embodiments of the present general inventive concept;

FIG. 14 is a diagram illustrating an update operation of a data storage device in which compressed data and uncompressed/raw data are stored according to exemplary embodiments of the present general inventive concept;

FIG. 15 is a block diagram illustrating a solid state drive (SSD) to which compression according to exemplary embodiments of the present general inventive concept may be applied;

FIG. 16 is a block diagram illustrating a storage using an SSD illustrated in FIG. 15 according to exemplary embodiments of the present general inventive concept;

FIG. 17 is a block diagram illustrating a storage server using an SSD illustrated in FIG. 15 according to exemplary embodiments of the present general inventive concept;

FIG. 18 is a block diagram illustrating a storage according to exemplary embodiments of the inventive concept;

FIG. 19 is a block diagram illustrating a storage server using a storage illustrated in FIG. 18 according to exemplary embodiments of the present general inventive concept; and

FIGS. 20 to 22 are diagrams illustrating systems including a data storage device according to exemplary embodiments of the present general inventive.

### DETAILED DESCRIPTION OF THE EMBODIMENTS

The present general inventive concept is described more fully hereinafter with reference to the accompanying drawings, in which embodiments of the present general inventive concept are illustrated. This inventive concept may, however, be embodied in many different forms and should not be construed as limited to the embodiments set forth herein. Rather, these embodiments are provided so that this disclosure will be thorough and complete, and will fully convey the scope of the inventive concept to those skilled in the art. In the drawings, the size and relative sizes of layers and regions may be exaggerated for clarity. Like numbers refer to like elements throughout.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the inventive concept.

Spatially relative terms, such as “beneath”, “below”, “lower”, “under”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” or “under” other elements or features would then be oriented “above” the other elements or features. Thus, the exemplary terms “below” and “under” can encompass both an orientation of above and below. The device may be otherwise oriented (rotated 90 degrees or at other orientations) and the spatially relative descriptors used herein interpreted accordingly. In addition, it will also be understood that when a layer is referred to as being “between” two layers, it can be the only layer between the two layers, or one or more intervening layers may also be present.

The terminology used herein is for the purpose of describing particular embodiments only and is not intended to be limiting of the inventive concept. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

It will be understood that when an element or layer is referred to as being “on”, “connected to”, “coupled to”, or “adjacent to” another element or layer, it can be directly on, connected, coupled, or adjacent to the other element or layer, or intervening elements or layers may be present. In contrast, when an element is referred to as being “directly on,” “directly connected to”, “directly coupled to”, or “immediately adjacent to” another element or layer, there are no intervening elements or layers present.

Unless otherwise defined, all terms (including technical and scientific terms) used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and/or the present specification and will not be interpreted in an idealized or overly formal sense unless expressly so defined herein.

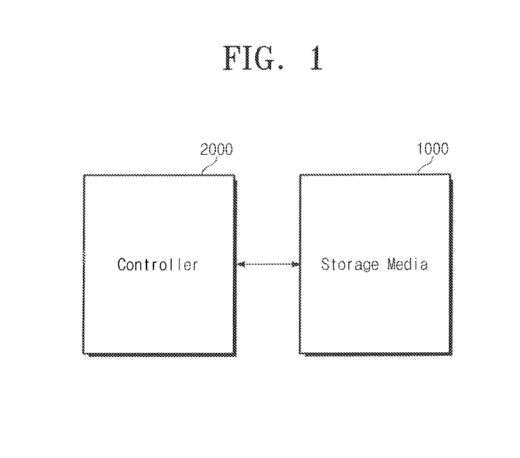

FIG. 1 is a block diagram illustrating a data storage device according to exemplary embodiments of the present general inventive concept.

Referring to FIG. 1, a data storage system can include a storage media 1000 and a controller 2000. The storage media 1000 can store data information having one or more types such as text, graphics, software codes, and the like. The storage media 1000, for example, can be a non-volatile memory such as PRAM (Phase change Random Access Memory), FeRAM (Ferroelectric Random Access Memory), MRAM (Magnetoresistive Random Access Memory), or any other suitable non-volatile memory to carry out the exemplary embodiments of the present general inventive concept as disclosed herein. The controller 2000 can control the storage media 1000 in response to external requests. The controller 2000 can compress data from an external device and can store the compressed data in the storage media 1000. The controller 2000 may be a processor, a programmable logic device, a field programmable gate array, an application specific integrated circuit, one or more electronic circuits, and/or any suitable controller to control the storage media 1000 and to compress received data. By compressing the data, the storage capacity of the storage media 1000 may be used with increased efficiency and efficacy, as the compressed data may utilize less capacity than uncompressed data. For example, the storage media 1000 can store an increased amount of data with lower and/or reduced cost. With the data compression, it is possible to reduce the amount of data transferred between the storage media 1000 and the controller 2000. That is, with the data compression, a transfer time taken to transfer data between the storage media 1000 and the controller 2000 can be reduced and/or decreased.

In exemplary embodiments of the present general inventive concept, the controller 2000 can divide externally provided data (hereinafter, referred to as non-compressed/raw data) and to compress divided data units (or, sub-groups). A division unit (or, a compression unit) of raw data can be determined variably as described below. The division unit can be changed so as to fit a size of compressed data of a divided data unit (or, a sub-group) to a physical storage unit of the storage media 1000. The storage media 1000 may be used with increased efficiency by fitting a size of compressed data of a divided data unit (or, a sub-group) to a physical storage unit of the storage media 1000. This will be more fully described below.

In exemplary embodiments of the present general inventive concept, a physical storage unit (or, a compression/division unit) of the storage media 1000 may be set to a word unit, a page unit, a sector unit, a block unit, a super-block unit, or the like, based on a non-volatile memory applied to the storage media 1000. When a non-volatile memory has an M-plane array structure (M being 2 or more integer), the super-block can be formed of N memory blocks in each of M planes and in the same row. N may be an integer less than M.

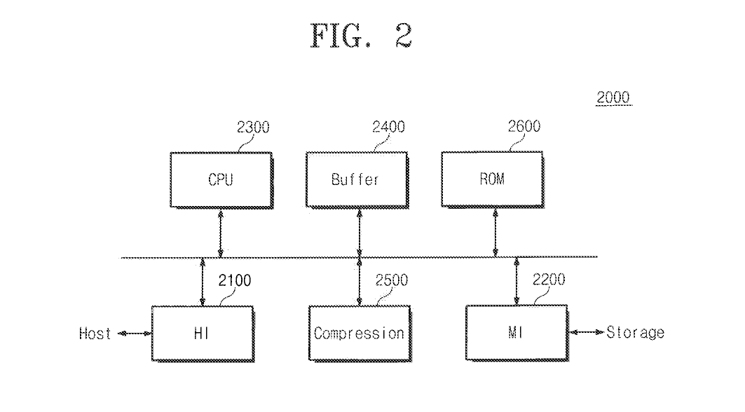

FIG. 2 is a block diagram illustrating the controller of FIG. 1 according to exemplary embodiments of the present general inventive concept.

Referring to FIG. 2, a controller 2000 can include the first interface 2100, the second interface 2200, CPU 2300, a buffer 2400, a compression block 2500, and ROM 2600. The CPU 2300 may be a central processing unit, a processor, a field programmable gate array, a programmable logic device, an application specific integrated circuit, and/or any other suitable device to carry out the exemplary embodiments of the present general inventive concept. The ROM 2600 may be a read-only memory including data and/or firmware that may be read and/or executed by the CPU 2300.

The first interface 2100 can interface with an external device (or, a host). The first interface 2100 may include one or more electrical circuits so that the controller 2000 may communicate with an external device and/or host. The second interface 2200 can interface with a storage media 1000 illustrated in FIG. 1. The second interface 2200 may include one or more electrical circuits so that the controller 2000 may communicate with the storage media 1000 illustrated in FIG. 1. As a processing unit, the CPU 2300 can control the operation of the controller 2000. For example, the CPU 2300 can execute firmware such as a memory translation layer (MTL) stored in the ROM 2600. As will be described, the MTL can manage memory mapping information and a division/compression unit of stream data. But, the MTL is not limited to this disclosure. For example, the MTL can manage wear-leveling, bad blocks, data retention because of unexpected power interruption, and the like.

The buffer 2400 can temporarily store data transferred from an external device via the first interface 2100. The buffer 2400 can temporarily store data transferred from the storage media 1000 via the second interface 2200. The compression block 2500 can operate according to the control of the CPU 2300 (or, the control of MTL executed by the CPU 2300) and can compress data that is sequentially provided from the buffer 2400 by a division unit. Each of compressed data can be stored in the storage media 1000 via the second interface 2500. The compression block 2500 can operate according to the control of the CPU 2300 (or, the control of MTL executed by the CPU 2300) and can decompress data read out from the storage media 1000. The compression block 2500 may be one or more electronic circuits, a programmable logic device, a field programmable gate array, or an application specific integrated circuit to compress the data that is sequentially provided, for example, from the buffer 2400. Alternatively, the compression block 2500 may be software and/or a combination of software and electronic circuits to compress the received data.

In exemplary embodiments of the present general inventive concept, a compression function of the compression block 2500 may be made optionally and/or selectively. Stream data can be stored in the storage media 1000 via the buffer 2400 without data compression. For example, an ON/OFF of the compression block 2500 may be made according to received stream data. That is, the compression block 2500 may operate so as to compress data when in an ON state, and may not compress the received data stream when in an OFF state. Data and/or information included in the received data stream may control the ON/OFF state of the compression block. When multimedia data that is compressed data is provided to a data storage device or when a predetermined amount of energy is consumed at data compression due to a predetermined small size of data, the compression block 2500 may be controlled to operate in an OFF state. The ON/OFF operation of the compression block 2500 may be made by hardware (for example, a register) or a software setting. Externally provided data can be stored directly in the storage media 1000 via the first and second interfaces 2100 and 2200 (i.e., without compression).

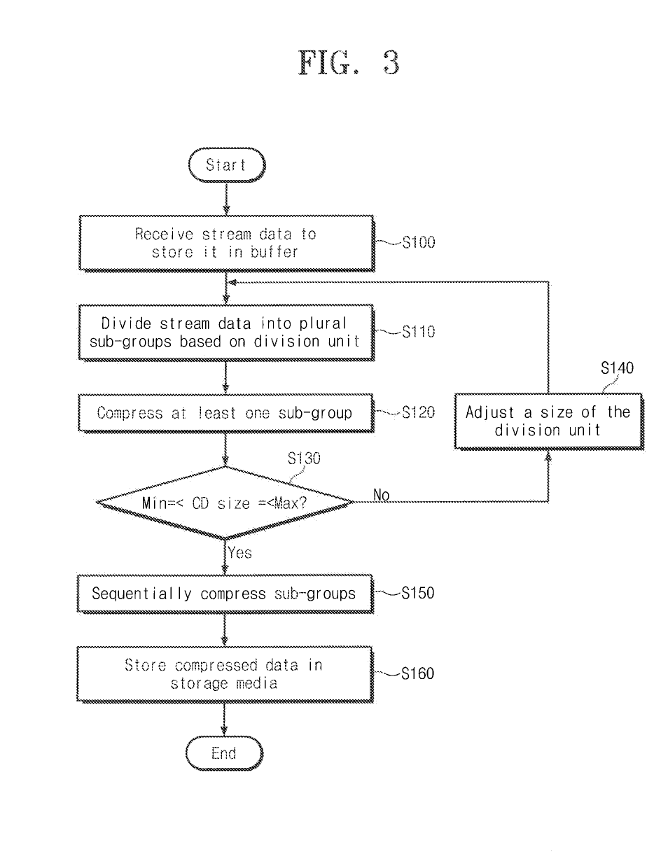

FIG. 3 is a flow chart illustrating a write operation of a data storage device according to exemplary embodiments of the present general inventive concept. Below, a write operation of a data storage device according to exemplary embodiments of the present general inventive concept will be more fully described with reference to accompanying drawings.

In operation S100, stream data externally provided upon write request can be stored in a buffer 2400 via a first interface 2100 that is controlled by the CPU 2300. The stream data stored in the buffer 2400 can be compressed by a compression block 2500 before stored in a storage media 1000. The data stream can be compressed as follows. In operation S110, the stream data in the buffer 2400 can be divided into a plurality of sub-groups according to a division unit. In exemplary embodiments of the present general inventive concept, a size of the division unit (or, a compression unit) can be varied (i.e., not fixed). Herein, division of the stream data can be that the amount of data corresponding to a size of the division unit (or, sub-group) can be transferred to the compression block 2500 under the control of the CPU 2300. In operation S120, the compression block 2500 can compress data provided from the buffer 2400 by the division unit, that is, at least one sub-group of data. If no compression algorithm of the compression block 2500 is changed, a size of compressed data (CD) may be varied according to one or more attributes of the stream data (for example, a pattern-repeated frequency, a pattern-repeated length, etc.). In other words, a compression rate of stream data to compressed data may be different according to the one or more attributes of the stream data.

In operation 130, the CPU 2300, that is, a Memory Translation Layer (MTL) can determine whether a size of the compressed data (CD) satisfies a reference condition (e.g., a predetermined reference condition). That is, the Memory Translation Layer (MTL) can determine whether a size of the compressed data (CD) is identical to or more than a minimum value Min and identical to or less than a maximum value Max. In exemplary embodiments of the present general inventive concept, the values Min and Max may be determined based on a physical storage unit LWU of the storage media 1000: word, page, sector, block, super-block, etc. For example, the minimum value Min can be LWU*0.95, and the maximum value Max is LWU*1. When the size of the compressed data (CD) is between the minimum value Min and the maximum value Max, a remaining space of a physical storage region of the storage media 1000 may be negligibly small when compressed data is stored in a corresponding physical storage region of the storage media 1000.

When the size of the compressed data (CD) is determined to be less than the minimum value Min or more than the maximum value Max, operation S140 can adjust the size of the division unit under the control of the CPU 2300 (or, MTL operated by the CPU 2300). For example, when the size of the compressed data (CD) is determined to be less than the minimum value Min, the size of the division unit can be adjusted so as to be increased. When the size of the compressed data (CD) is determined to be more than the maximum value Max, the size of the division unit can be adjusted so as to be decreased. The above-described operations S110 to S140 can be repeated until the size of the compressed data (CD) is identical to or more than the minimum value Min and identical to or less than the maximum value Max.

Retuning to operation S130, when the size of the compressed data (CD) is determined to be identical to or more than the minimum value Min and identical to or less than the maximum value Max, the compression block 2500 can sequentially compress sub-groups by dividing the stream data by a division unit determined by the above-described process at operation 5150. Data sequentially compressed by the compression block 2500 in operation 5160 can be stored in the storage media 1000 via a second interface 2200.

As understood from the above description, a remaining space of a physical storage unit of the storage media 1000 that may exist after storing of compressed data therein can be minimized by fitting a size of compressed data to a physical storage unit of the storage media 1000.

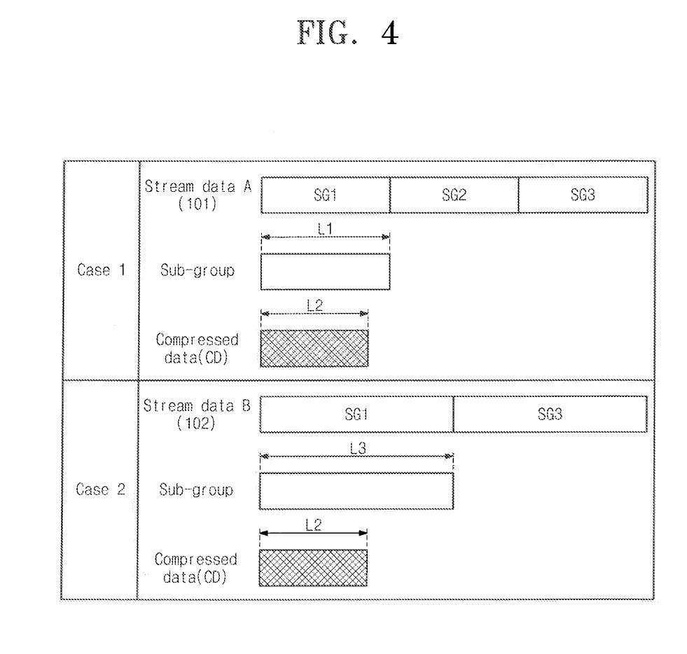

FIG. 4 is a diagram illustrating a division unit that may be varied according to attributes of stream data provided to a data storage device according to exemplary embodiments of the present general inventive concept. As described above, a division unit (or, a size of each of sub-groups of stream data) can be varied according to attributes of stream data.

For example, the stream data 101 may be divided into a plurality of subgroups SG1 to SG3, and the sub-groups SG1 to SG3 may be compressed as described above in connection with FIG. 3. Herein, a division unit L1 of the stream data 101 can be determined by repetitively determining whether a size of compressed data satisfies a given condition (i.e., a predetermined condition), and which may be performed in substantially the same manner as described above in connection with FIG. 3. In exemplary embodiments of the present general inventive concept, the division of stream data 102 into a plurality of sub-groups SG1 and SG2 and compression of the sub-groups SG1 and SG2 can be made in the same manner as described above in connection with FIG. 3. Herein, a division unit L2 of the stream data 102 can be determined by repetitively determining whether a size of compressed data satisfies a given condition (i.e., a predetermined condition), and which is performed in the substantially same manner as described above in connection with in FIG. 3.

In exemplary embodiments of the present general inventive concept, it can be assumed that an attribute of the stream data 101 can be different from that of the stream data 102 and that a size of the stream data 101 can be identical to that of the stream data 102. With the assumption, as illustrated in FIG. 4, a division unit L1 of the stream data 101 can be different from that of L3 of the stream data 102. Although the division unit L1 of the stream data 101 can be different from that of L3 of the stream data 102, a size L2 of compressed data CD of each of the sub-groups SG1 to SG3 of the stream data 101 can be identical to that of L2 of compressed data CD of each of the sub-groups SG1 and SG2 of the stream data 102. Compressed data CD can be stored in a space corresponding to a physical storage unit of the storage media 1000: page, sector, block, super-block, or the like. Since a size of compressed data CD can be determined to be fitted to a physical storage unit of the storage media 1000, a remaining space of the storage media 1000 (or, each physical storage unit of the storage media 1000) can be minimized after the compressed data CD is stored therein.

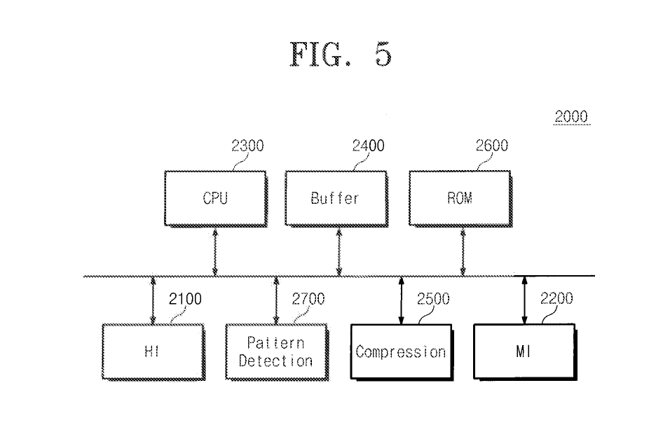

FIG. 5 is a block diagram illustrating a controller in FIG. 1 according to exemplary embodiments of the present general inventive concept.

In FIG. 5, elements which are identical to those in FIG. 3 are marked by the same numerals, and description thereof is thus omitted. As illustrated in FIG. 5, a controller 2000 can include a first interface 2100, a second interface 2200, a CPU 2300, a buffer 2400, a compression block 2500, ROM 2600, and a pattern detecting block 2700.

The pattern detecting block 2700 can be controlled by the CPU 2300 (or, a memory translation layer (MTL) operated by the CPU 2300) and can detect one or more attributes of raw data. The pattern detecting block 2700 may be one or more circuits, a processor, a field programmable gate array, a programmable logic device, and/or any other suitable circuits to detect patterns in data according to the exemplary embodiments of the present general inventive concept as disclosed herein. The pattern detecting block may be a combination of software and electrical circuits to detect patterns in data according to exemplary embodiments of the present general inventive concept. For example, the pattern detecting block 2700 can detect attributes (for example, a pattern-repeated frequency, a pattern-repeated length, etc.) of stream/raw data based on data (or, a part of stream data) transferred to the buffer 2400 from the first interface 2100 and can predict a compression rate of stream data according to the detected attribute information. The predicted compression rate can adjust a division unit of stream data, which will be described below.

In an exemplary embodiments of the present general inventive concept, prediction of the compression rate may be made based on a size difference between compressed data generated by compressing a part of data to be stored in a storage media, and uncompressed (or, before-compression) data.

In exemplary embodiments of the present general inventive concept, prediction of the compression rate may be made by the compression block 2500 instead of the pattern detecting block 2700. Alternatively, a controller 2000 can control the pattern detecting block 2700 to detect attributes of stream data and control the compression block 2500 to predict the compression rate according to the detected attributes.

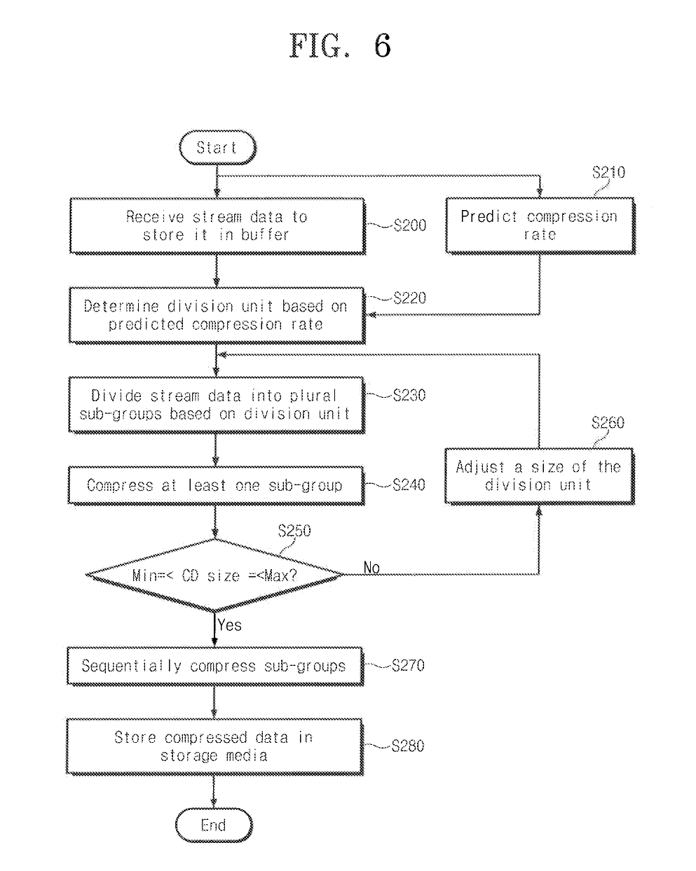

FIG. 6 is a flow chart illustrating a write operation of a data storage device according to exemplary embodiments of the present general inventive concept. Below, a write operation of a data storage device according to exemplary embodiments of the present general inventive concept will be more fully described with reference to accompanying drawings.

In operation 5200, stream data externally provided upon write request can be stored in a buffer 2400 via a first interface 2100 under the control of CPU 2300. At the same time, in operation 5210, a pattern detecting block 2700 can predict a compression rate based on stream data transferred to the buffer 2400. Prediction of the compression rate may be made according to one or more attributes of the stream data such as a pattern-repeated frequency, a pattern-repeated length, etc. In operation 3220, the CPU 2300 (or, MTL operated by the CPU 2300) can determine a division unit based on the predicted compression rate. In operation 230, the stream data stored in the buffer 2400 can be divided into a plurality of sub-groups based on the division unit determined in the step S220. As described above, division of the stream data can include where the amount of data corresponding to a size of the division unit (or, sub-group) can be transferred to the compression block 2500 under the control of the CPU 2300. In operation S240, the compression block 2500 can compress data provided from the buffer 2400 by the division unit, that is, at least one sub-group of data.

In operation 250, the CPU 2300, that is, a Memory Translation Layer (MTL) can determine whether a size of the compressed data (CD) is identical to or more than a minimum value Min and identical to or less than a maximum value Max. In exemplary embodiments of the present general inventive concept, the values Min and Max may be determined based on a physical storage unit LWU of the storage media 1000: word, page, sector, block, super-block, etc. For example, the minimum value Min can be LWU*0.95, and the maximum value Max can be LWU*1. The size of the compressed data (CD) that exists between the minimum value Min and the maximum value Max can include where a remaining space of a physical storage region of the storage media 1000 is negligibly small after compressed data is stored in a corresponding physical storage region of the storage media 1000.

When the size of the compressed data (CD) is determined to be less than the minimum value Min or more than the maximum value Max, the size of the division unit can be adjusted under the control of the CPU 2300 (or, MTL operated by the CPU 2300) in operation S260. For example, when the size of the compressed data (CD) is determined to be less than the minimum value Min, the size of the division unit can be adjusted so as to be increased. When the size of the compressed data (CD) is determined to be more than the maximum value Max, the size of the division unit can be adjusted to be decreased, and the operation S230 can be performed. The above-described operations S230 to S260 can be repeated until the size of the compressed data (CD) is identical to or more than the minimum value Min and identical to or less than the maximum value Max.

Retuning to operation 5250, when the size of the compressed data (CD) is determined to be identical to or more than the minimum value Min and identical to or less than the maximum value Max, operation 5270 can be performed, in which the compression block 2500 sequentially compresses sub-groups taken by dividing the stream data by a division unit determined by the above-described operations. Data sequentially compressed by the compression block 2500, in operation S280, can be stored in the storage media 1000 via a second interface 2200.

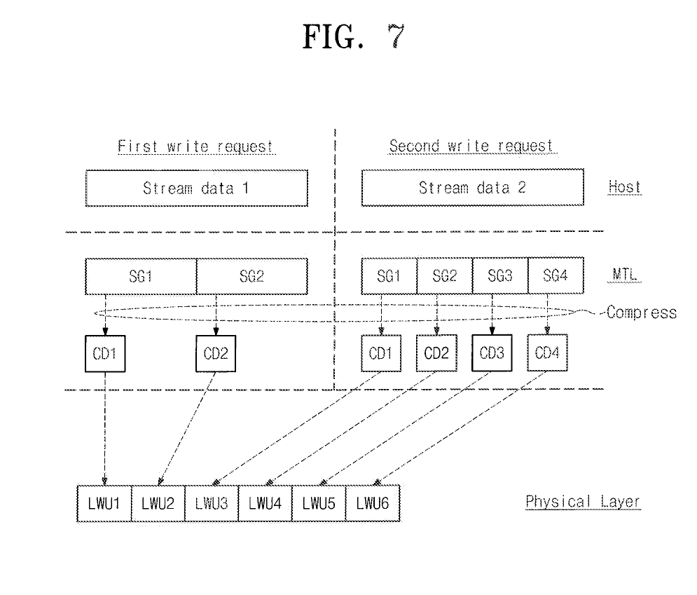

As understood from the above description, a division unit (or, a compression unit) of raw data transferred from a host can be adjusted to be variable (i.e., not fixed). A size of compressed data can be maintained constantly. Referring to FIG. 7 which illustrates a write flow of a data storage device according to exemplary embodiments of the present general inventive concept, a memory translation layer (MTL) can divide write-requested stream data into a plurality of sub-groups according to the operations illustrated in FIG. 3 or 5, and as described above in connection with these figures. For example, it can be assumed that the same size of stream data is provided to a data storage device upon first and second write requests and that attributes of stream data provided at the first write request are different from attributes of stream data provided at the second write request. With this assumption, stream data SD1 provided at the first write request can be divided into two sub-groups, and stream data SD2 provided at the second write request can be divided into four sub-groups. Although division sizes of the stream data SD1 and SD2 can be different from each other, a size of compressed data CD of each sub-group can be maintained identically with respect to the stream data SD1 and SD2. Compressed data with the same size can be stored in a physical layer, that is, a corresponding physical storage unit LWU of a storage media 1000.

In exemplary embodiments of the present general inventive concept, one or more operations and/or a part of functions (for example, a function of determining a division size) of the MTL may be made at a host level. Information indicating a division size (or, a compression size) can be provided to a data storage device together with stream data, and the data storage device can perform at least one compression operation according to the externally provided information (that is, a division size). Alternatively, data can be transferred to the data storage device according to a division size (or, a compression size) that may be determined at a host level.

In exemplary embodiments of the present general inventive concept, a physical storage unit LWU can be formed of a writable unit WU or a plurality of writable units. The writable unit WU can be a unit by which memory cells may be programmed at the same time. The writable unit WU, for example, can include a word, a page, a plurality of sectors, etc.

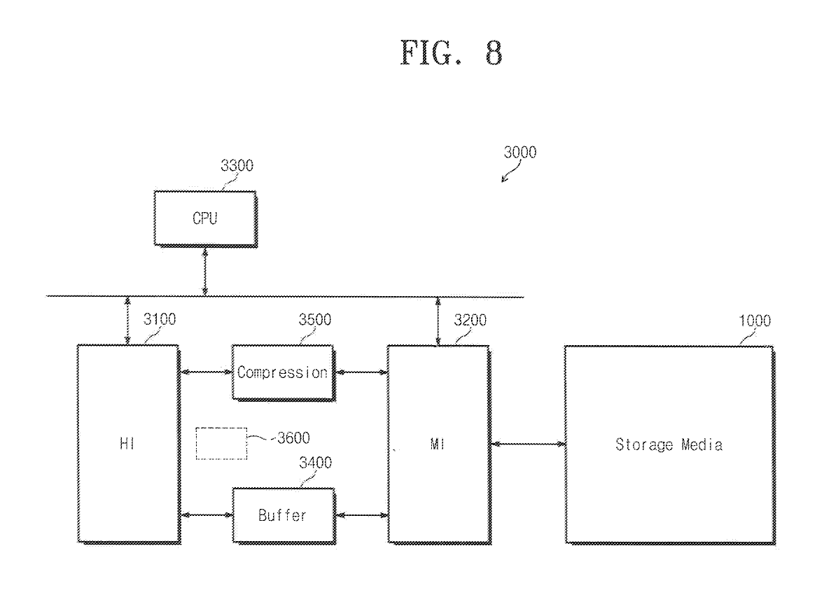

FIG. 8 is a block diagram illustrating a data storage device according to exemplary embodiments of the present general inventive concept.

Referring to FIG. 8, a data storage device can include a storage media 1000 and a controller 3000. The storage media 1000 can be the same illustrated in FIG. 1 and described above. The controller 3000 can include first and second interfaces 3100 and 3200, CPU 3300, a buffer 3400, and a compression block 3500. The first and second interfaces 3100 and 3200 may be the same as the first and second interfaces 2100 and 2200 illustrated in FIG. 2 and described above. The buffer 3400 may transfer data between the first and second interfaces 3100 and 3200 under the control of the CPU 3300. The compression block 3500 can compress data transferred via the first interface 3100 under the control of the CPU 3300 (or, MTL operated by the CPU 3300). The compression block 3500 may include a buffer to store data. A unit compressed by the compression block 3500, that is, a division unit of stream data, can be controlled variably in the same manner as described above in connection with FIG. 3. When a division unit is determined in a manner illustrated in FIG. 6 and described above, the controller 3000 may include a pattern detecting block 3600 to detect attributes of stream data.

In exemplary embodiments of the present general inventive concept, a data storage device may have a compression block 3500 that may be turned on or off (i.e., have ON/OFF operational states). For example, determining ON/OFF of the compression block 3500 can be made according to received stream data. When multimedia data that is compressed data is provided to a data storage device, or when a predetermined amount of energy is consumed upon data compression due to a predetermined small size of data, the compression block 3500 may operate in an OFF state. When the compression block 3500 is disabled, data can be transferred to a storage media 1000 via the buffer 3400.

Changing the ON/OFF operation of the compression block 3500 may be made by a hardware (for example, register) or a software setting. Externally provided data can be stored directly in the storage media 1000 via the first and second interfaces 2100 and 2200. Alternatively, data can be stored directly in the storage media 1000 via the first and second interfaces 3100 and 3200. Stream data provided via the first interface 3100 can be stored in both the buffer 3400 and a buffer of the compression block 3500. Either one of data in the buffer 3400 and data compressed by the compression block 3500 can be stored in the storage media 1000 according to whether a compression operation is activated or inactivated.

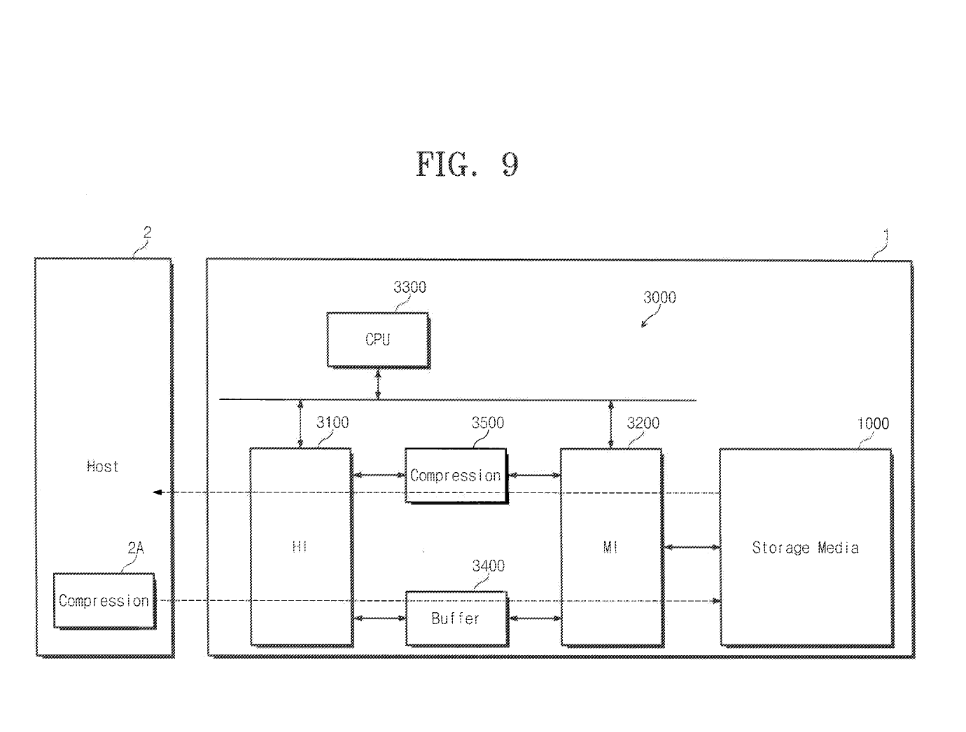

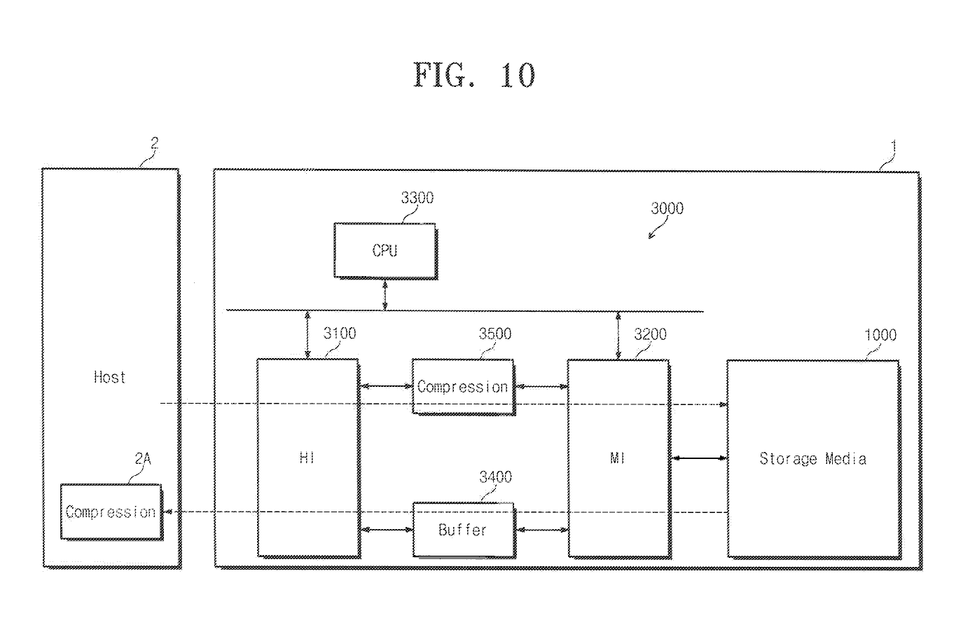

FIGS. 9 and 10 are block diagrams illustrating systems that include a data storage device according to exemplary embodiments of the present general inventive concept.

FIG. 9 illustrates a system that can include a data storage device 1 and a host 2. The host 2 can include a compression block 2A which can compress data to be transferred to the data storage device 1. The data storage device 1 illustrated in FIG. 9 can be the same as illustrated in FIG. 8 and described above, including the controller 3000. The controller 2000 illustrated in FIG. 2 or 5 and described above may be used as a controller of the data storage device 1 illustrated in FIG. 9 the controller 3000.

With the above-described system, the host 1 can transmit and/or send data that is compressed by the compression block 2A to the data storage device 1, and the transferred data can be stored in the storage media 1000 via the buffer 3400. When data is transferred to the host 2 from the data storage device 1, compression of data read out from a storage media 1000 can be released by a compression block 3500 of the data storage device 1, and decompressed data can be sent to the host 2. The same compression algorithm can be applied to the compression blocks 2A and 3500.

As illustrated in FIG. 10, a host 2 can transmit and/or send raw data to a data storage device 1, and the raw data can be compressed by a compression block 3500. Compressed data can be stored in a storage media 1000. When data is transferred to the host 2 from the data storage device 1, data read out from the storage media 1000 can be transmitted and/or sent to the host 2 via the buffer 3400, and a compression block 2A of the host 2 can release compression of data (i.e., decompress the data) transferred from the data storage device 1.

As described above, a memory translation layer (MTL) that may be controlled by CPU may manage one or more mapping tables. For ease of description, it may be assumed that the storage media 1000 can be formed of NAND flash memories, and that NAND flash memories can be managed in a log mapping manner, as discussed in detail below.

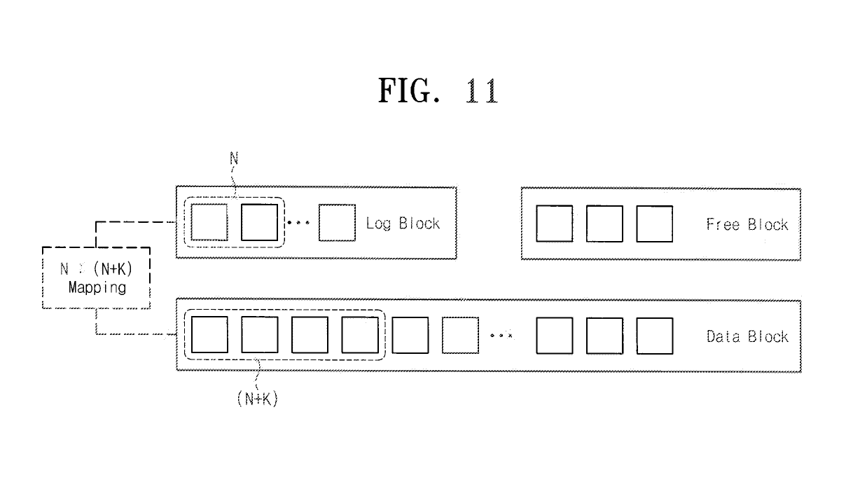

FIG. 11 is a diagram illustrating a log mapping manner which can be applied to a data storage device according to exemplary embodiments of the present general inventive concept.

Referring to FIG. 11, a memory translation layer MTL can classify memory blocks of a storage media 1000 into data blocks, log blocks, and free blocks. A data block may be a block in which data is previously stored, and a free block may be a block in which no data is stored. A log block may temporarily store data provided from an external device before it is stored in a data block. Log blocks may operate as a write buffer. Upon an initial use of the data storage device, data can be sequentially stored in log blocks. Among log blocks, a fulfilled block can be changed to a data block. Log blocks and data blocks can be related so as to have an N: (N+k) mapping. That is, N log blocks can be mapped to (N+k) data blocks.

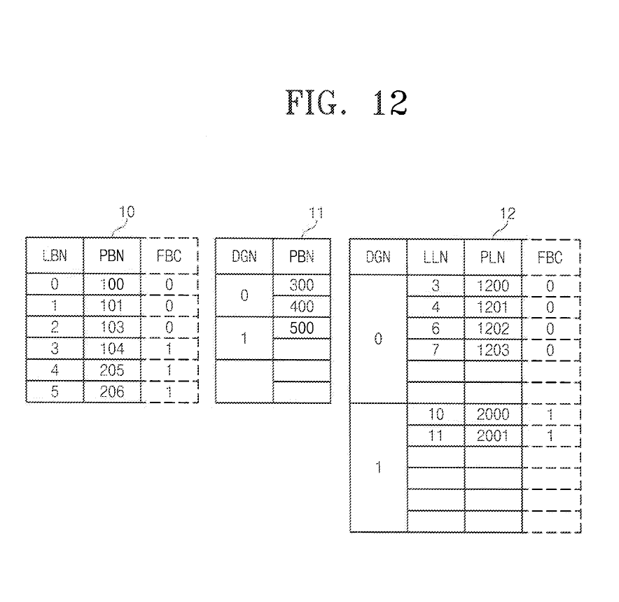

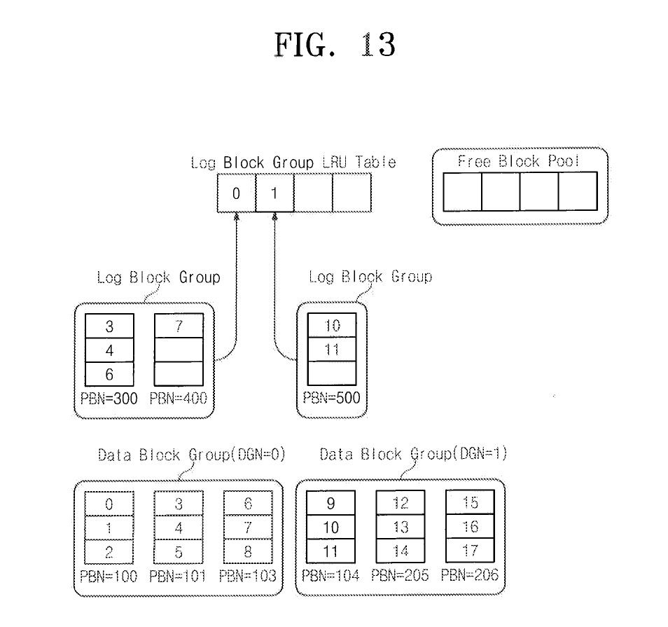

FIG. 12 is a diagram illustrating tables that may be managed by a memory translation layer (MTL) applied to a data storage device according to exemplary embodiments of the present general inventive concept, and FIG. 13 can be a diagram illustrating assignment of log blocks when a write operation is performed.

In FIG. 12, “LBN” may be a logical block number, “PBN” may be a physical block number, “LLN” may be a logical LWU number, and “PLN” may be a physical LWU number. Tables managed by the MTL may include a data block mapping table 10, a log block mapping table 11, an LWU mapping table 12, a compression block mapping table, a log block group LIEU table, and the like. The compression mapping table can include flag bit information to indicate whether data in a data block is compressed data or raw data. As illustrated by a dotted line in FIG. 12, the compression mapping table can be included in the data block mapping table 10 or the LWU mapping table 12. Alternatively, the compression mapping table can be included in both the data block mapping table 10 and the LWU mapping table 12. Preferably, the compression mapping table can be included in either one of the tables 10 and 12. As illustrated in FIG. 12, for example, corresponding flag bits FBC of blocks 100, 101, and 103 can be set to ‘0’, which means that they store raw data. Corresponding flag bits FBC of blocks 104, 205, and 206 can be set to ‘1’, which means that they store compressed data.

For ease of description, assignment of log blocks performed upon a write operation will be described with the assumption that a logical writable unit (LWU) has a page size. It may be assumed that a command directing that two pages are stored from a logical LWU number LLN3 is received. When there is no block assigned to a log block, the MTL can assign one of the free blocks in a free block pool to a log block, and can generate a log block group with respect to a data block group DGN0. Logical LWU numbers LLN3 and LLN4 can be recorded in the first and second pages 1200 and 1201 of the assigned log block PBN300. The MTL can store mapping information in an LWU mapping table 12. Flag bit information FBC can be stored to indicate whether data is uncompressed/raw data or compressed data. When the data is compressed data, the MTL can assign a new data block.

When a command is received directing that two pages are stored from a logical LWU number LLN6, data of the LLN6 can be stored in a log block PBN300, and the MTL can assign one of free blocks in the free block pool as a new log block PBN400 since a storage space of the log block PBN300 may be insufficient. The log block PBN400 can be added to the data block group DGN0, and data of a logical LWU number LLN7 can be stored in the log block PBN400.

When a command is received that directs that two pages are stored from a logical LWU number LLN10, because no logical LWU number LLN10 belongs to the data block group DGN0, a new log block PBN500 can be assigned. The MTL can generate a data block group DGN1 including a new-assigned log block PBN500. Because flag bit information FBC can be set to 1, data stored in a log block can be compressed data. Data of logical LWU numbers LLN10 and LLN11 can be stored in the new-assigned log block PBN500, and mapping information can be stored in the LWU mapping table 12.

The above-described operations may be performed until no free block pool includes at least one free block. When no free block pool includes at least one free block, an erase operation can be performed. With the above-described mapping, one data block group can be mapped to one log block group.

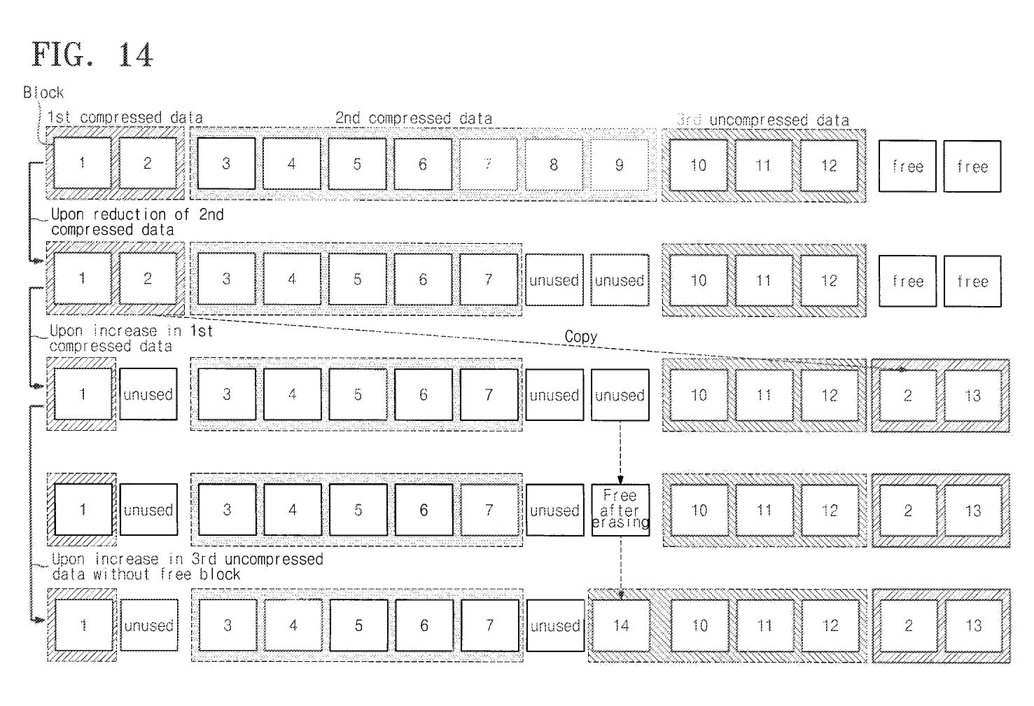

FIG. 14 is a diagram illustrating an update operation of a data storage device in which compressed data and uncompressed/raw data can be stored.

Referring to FIG. 14, it may be assumed that the first compressed data can be stored in two blocks (e.g., blocks 1 and 2), that the second compressed data can be stored in seven blocks (e.g., blocks 3 to 9), and that the third uncompressed data can be stored in three blocks (e.g., blocks 10, 11, and 12). For example, when an update operation may be performed to reduce the second compressed data, an update-requested portion (for example, two blocks 8 and 9) can be appointed to an unused block. An erase operation for the unused block is not carried out.

When an update operation increases the first compressed data, update-requested data may not be stored in a block (for example, 2) having an empty space among blocks 1 and 2 of the first compressed data, but can be stored in new-assigned log blocks as follows. The block with an empty space can be assigned to an unused block, and two free blocks can be assigned to a log block. The new-assigned log blocks can be used to update of the first compressed data. Data in the block 2 with an empty space can be moved to a new-assigned log block, and update-requested data can be stored in a remaining space of the new-assigned log blocks.

It may be assumed that an update is requested when a free block pool does not include a free block. For example, an update that increases the third uncompressed data may occur when a free block pool does not include a free block. When there is no free block to be assigned to a log block, an erase operation can be carried with respect to one or more unused blocks. Erased blocks can be assigned to a free block. A free block can be assigned to a log block to update the third uncompressed data, and the update data can be stored in the new-assigned log block.

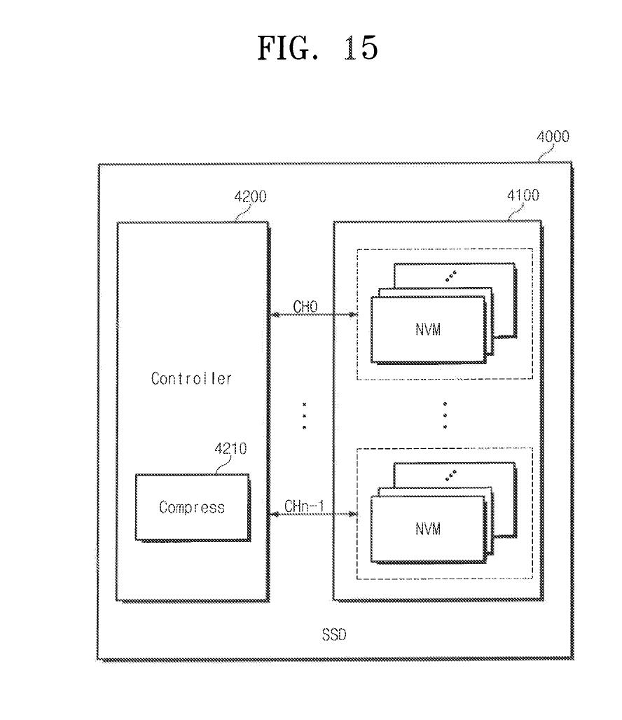

FIG. 15 is a block diagram illustrating a solid state drive (SSD) that may include data compression according to exemplary embodiments of the present general inventive concept.

Referring to FIG. 15, a solid state drive (SSD) 4000 can include a storage media 4100 and a controller 4200. The storage media 4100 can be communicatively connected with the controller 4200 via a plurality of channels (e.g., CHO to CHn−1), each of which can be commonly connected with a plurality of non-volatile memories. The controller 4200 can include a compression block 4210 which can compress data and release data compression (i.e., decompress the data). Although not illustrated in the figures, a pattern detecting block illustrated in FIG. 5 can be provided in the controller 4200.

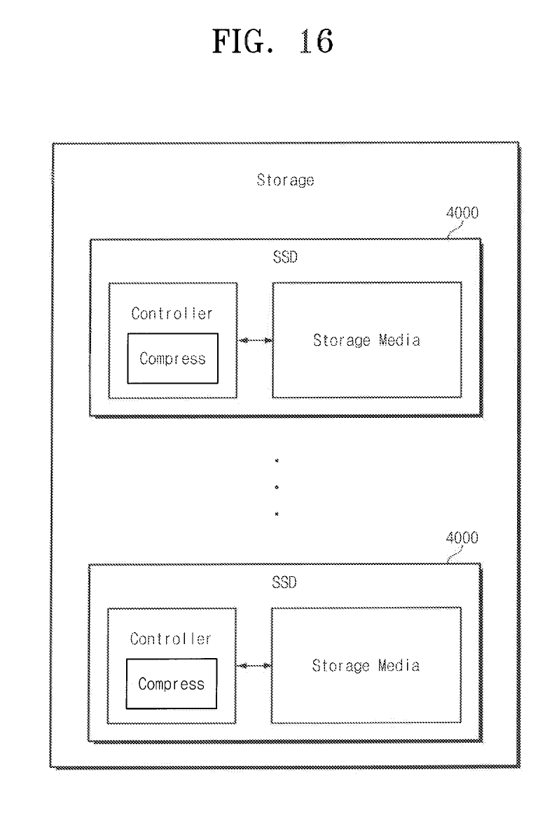

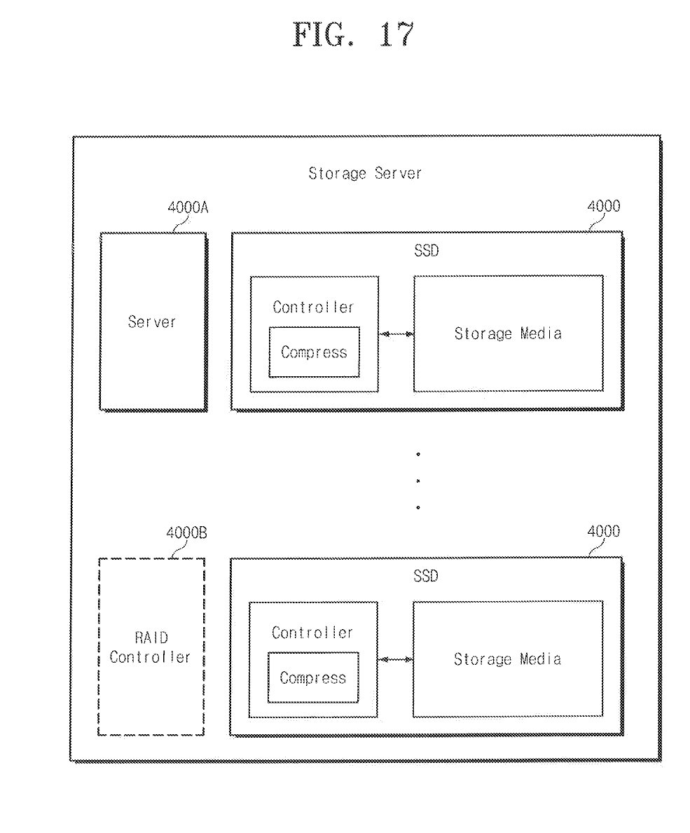

FIG. 16 is a block diagram illustrating a storage using an SSD illustrated in FIG. 15, and FIG. 17 is a block diagram illustrating a storage server using an SSD illustrated in FIG. 15.

An SSD 4000 according to exemplary embodiments of the present general inventive concept may be included in a storage illustrated in FIGS. 16 and 17. As illustrated in FIG. 16, a storage can include a plurality of solid state drives 4000 which may be the same as described above in connection with FIG. 15. An SSD 4000 according to exemplary embodiments of the present general inventive concept can be used to configure a storage sever. As illustrated in FIG. 17, a storage server can include a plurality of solid state drives 4000, which may be the same as described above in connection with FIG. 15, and a server 4000A. A well-known RAID controller 4000B can be provided in the storage server illustrated in FIG. 17.

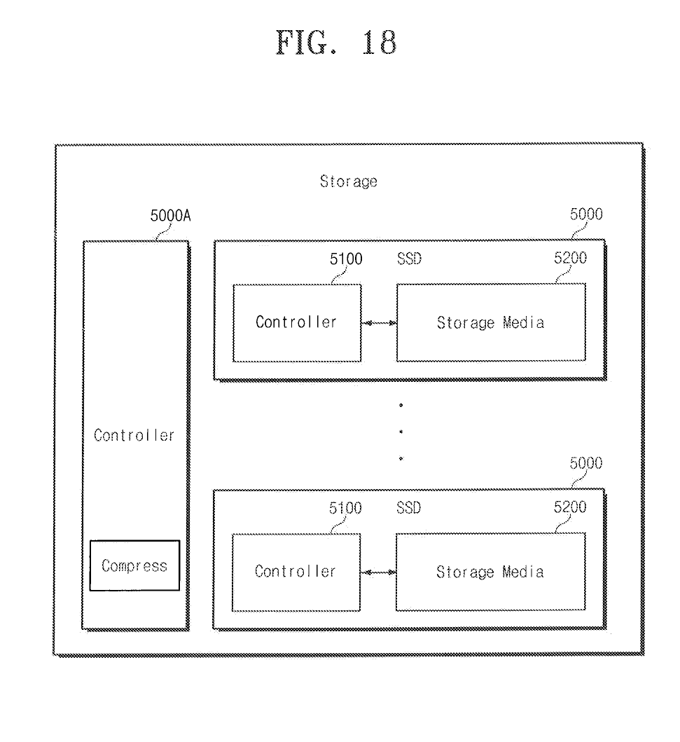

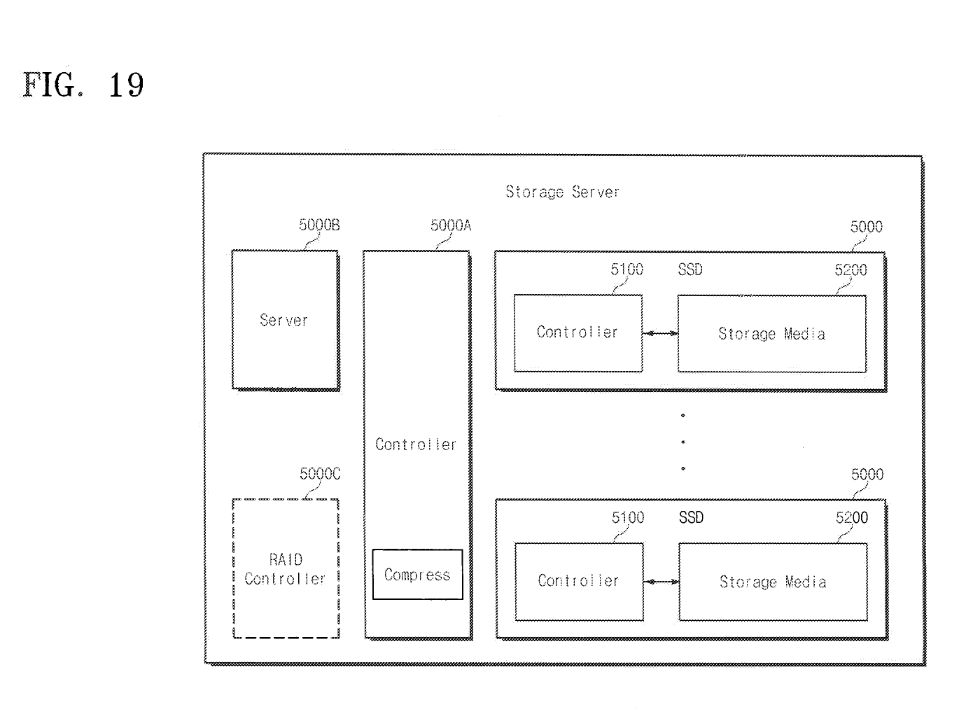

FIG. 18 is a block diagram illustrating a storage according to exemplary embodiments of the present general inventive concept, and FIG. 19 is a block diagram illustrating a storage server using the storage illustrated in FIG. 18 and described above.

Referring to FIG. 18, a storage can include a plurality of solid state drives 5000 and a control block 5000A. Each of the solid state drives 5000 can include a controller 5100 and a storage media 5200. The controller 5100 can perform an interface function with the storage media 5200. The solid state drives 5000 can be controlled by the control block 5000A, which may perform the above-described functions (for example, change of a division size and compression). The storage in FIG. 18 may be included in a storage server. As illustrated in FIG. 19, a storage server can include a server 5000B and a storage (e.g., SSD 5000, a storage included in control block 5000A) which may be the same as illustrated in FIG. 18. A well-known RAID controller 5000C can be provided in the storage server.

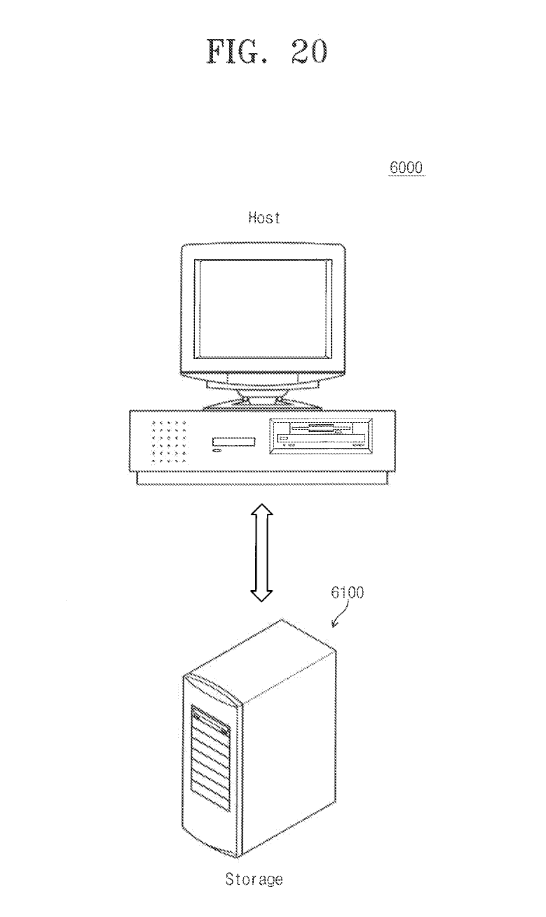

FIGS. 20 to 22 are diagrams illustrating systems including a data storage device according to exemplary embodiments of the present general inventive concept.

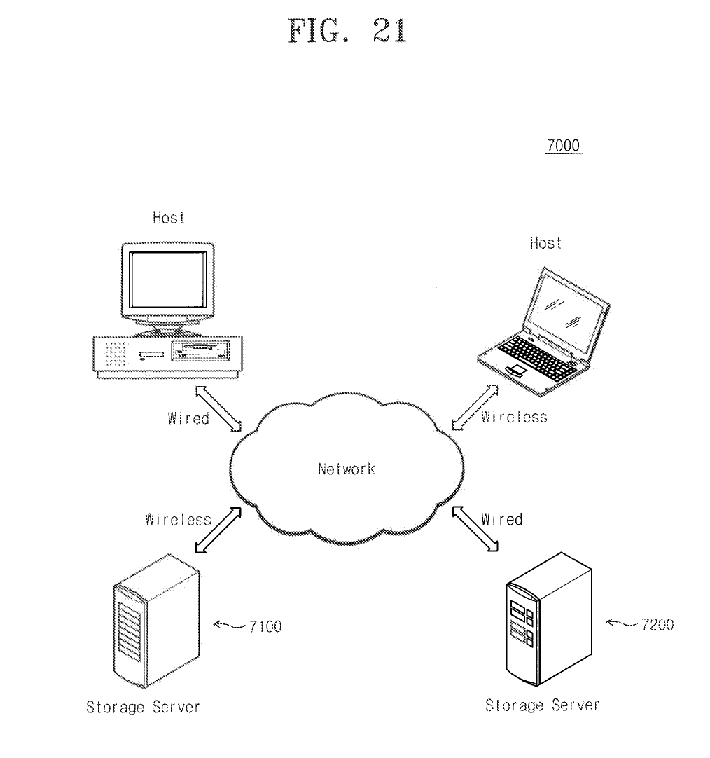

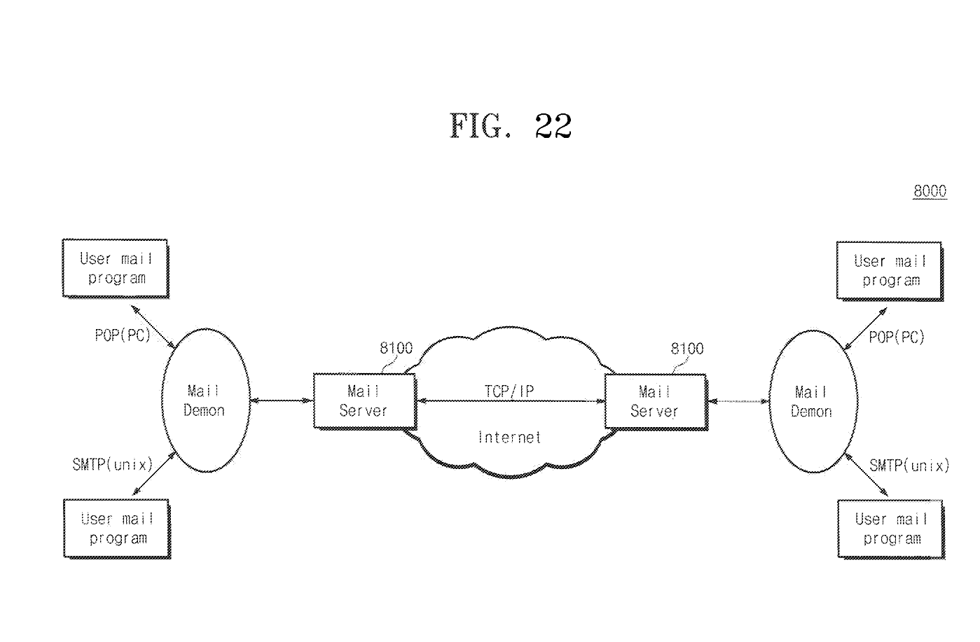

When a solid state drive including a data storage device according to exemplary embodiments of the present general inventive concept is applied to a storage, as illustrated in FIG. 20, a system 6000 can include a storage 6100 which communicates with a host by a wire or in a wireless manner. When a solid state drive including a data storage device according to exemplary embodiments of the present general inventive concept included in a storage server, as illustrated in FIG. 21, a system 7000 can include storage servers 7100 and 7200 which can communicate with a host by a wire or wireless manner. Further, as illustrated in FIG. 22, a solid state drive including a data storage device according to exemplary embodiments of the inventive concept can be applied to a mail server 8100 of the system 8000.

In exemplary embodiments of the present general inventive concept, a compression block 2500 of a controller 2000 may include one of the following compression algorithms or a combination of two or more compression algorithm. Compression algorithms may includes LZ77&LZ78, LZW (Lempel-Ziv-Welch), Entropy encoding, Huffman coding, Adpative Huffman coding, Arithmetic coding, DEFLATE, REG (Joint Photographic Experts Group), etc.

In exemplary embodiments of the present general inventive concept, a first interface 2100 of a controller 2000 may be formed of one of computer bus standards, storage bus standards, and iFCPPeripheral (Internet Fibre Channel Protocol) bus standards, or a combination of two or more standards. The computer bus standards may includes S-100 bus, Mbus, Smbus, Q-Bus, ISA (Industry Standard Architecture), Zorro II, Zorro III, CAMAC (Computer Automated Measurement and Control), FASTBUS, LPC (Low Pin Count bus), EISA (Extended Industry Standard Architecture), VME (VERSAmodule Eurocard bus), VXI (VME eXtensions for Instrumentation), NuBus, TURBOchannel, MCA (Micro Channel Architecture), Sbus, VLB (Video Electronics Standards Association Local Bus), PCI (Peripheral Component Interconnect), PXI (PCI eXtensions for Instrumentation), HP GSC bus, CoreConnect, InfiniBand, UPA (Ultra Port Architecture), PCI-X (Peripheral Component Interconnect eXtended), AGP (Accelerated Graphics Port), PCIe (Peripheral Component Interconnect Express), Intel® QuickPath Interconnect, Hyper Transport, etc. The storage bus standards may include ST-506, ESDI (Enhanced Small Disk Interface), SMD (Small Disk Interface), Parallel ATA (Advanced Technology Attachment), DMA (Direct Memory Access), SSA (Serial Storage Architecture), HIPPI (High Performance Parallel Interface), USB MSC, FireWire (1394), Serial ATA (Serial Advanced Technology Attachment), eSATA (external Serial Advanced Technology Attachment), SCSI (Small Computer System Interface), Parallel SCSI, Serial Attached SCSI, Fibre Channel, iSCSI (Internet Small Computer System Interface), SAS (Serial Attached SCSI), RapidIO, FOP (Fibre Channel over Internet Protocol), etc. The iFCPPeripheral bus standards may include Apple Desktop Bus, HIL, MIDI (Musical Instrument Digital Interface), Multibus, RS-232, DM 512-A, EIA/RS-422, IEEE-1284, UNIX), 1-Wire, I2C, SPI (Serial Peripheral Interface), EINRS-485, USB (Universal Serial Bus), Camera Link, External PCIe (Peripheral Component Interface Express), Light Peak Multidrop Bus, etc.

The present general inventive concept can also be embodied as computer-readable codes on a computer-readable medium. The computer-readable medium can include a computer-readable recording medium and a computer-readable transmission medium. The computer-readable recording medium is any data storage device that can store data as a program which can be thereafter read by a computer system. Examples of the computer-readable recording medium include read-only memory (ROM), random-access memory (RAM), CD-ROMs, magnetic tapes, floppy disks, and optical data storage devices. The computer-readable recording medium can also be distributed over network coupled computer systems so that the computer-readable code is stored and executed in a distributed fashion. The computer-readable transmission medium can be transmitted through carrier waves or signals (e.g., wired or wireless data transmission through the Internet). Also, functional programs, codes, and code segments to accomplish the present general inventive concept can be easily construed by programmers skilled in the art to which the present general inventive concept pertains.

The above-disclosed subject matter is to be considered illustrative, and not restrictive, and the appended claims are intended to cover all such modifications, enhancements, and other embodiments, which fall within the true spirit and scope. Thus, to the maximum extent allowed by law, the scope is to be determined by the broadest permissible interpretation of the following claims and their equivalents, and shall not be restricted or limited by the foregoing detailed description.

Although several embodiments of the present invention have been shown and described, it would be appreciated by those skilled in the art that changes may be made in these embodiments without departing from the principles and spirit of the general inventive concept, the scope of which is defined in the claims and their equivalents.

1. A method of storing data in a storage media, comprising:
sequentially compressing data by a compression unit; and
storing the compressed data in the storage media, the compression unit being varied according to a compression characteristic of data to be stored in the storage media.

2. The method of claim 1, wherein when the compression unit is varied according to the compression characteristic of data to be stored in the storage media, a size of compressed data corresponding to the compression unit is constant.

3. The method of claim 2, wherein the storage media comprises at least one non-volatile memory, the size of the compressed data corresponding to a word, a page, a sector, a block, and a super-block of the non-volatile memory.

4. The method of claim 3, wherein the sequentially compressing data by the compression unit comprises:
determining the compression unit of data to be stored in the storage media;
dividing the data to be stored into a plurality of sub-groups based on the determined compression unit; and
compressing data of each of the plurality of sub-groups.

5. The method of claim 4, wherein the determining the compression unit of data to be stored in the storage media comprises:
dividing data into a plurality of sub-groups according to a predetermined compression unit;
compressing at least one of the plurality of sub-groups; and
adjusting a size of the compression size according to whether a size of the compressed data of the at least one sub-group satisfies a reference condition.

6. The method of claim 4, wherein the determining the compression unit of data to be stored in the storage media comprises:
predicting a compression rate based on the compression characteristic of data to be stored in the storage media;
determining the compression unit based on the predicted compression unit;
dividing data into a plurality of sub-groups according to the predetermined compression unit;
compressing at least one of the plurality of sub-groups; and
adjusting a size of the compression size according to whether a size of compressed data of the at least one sub-group satisfies a reference condition.

7. The method of claim 1, further comprising:
determining whether data to be stored in the storage media is compressed data.

8. The method of claim 7, wherein when data to be stored in the storage media is determined not to be compressed data, data is stored in the storage media without compression.

9. A data storage device comprising:
a storage media; and
a controller to compress data to be stored in the storage media by a compression unit, the controller to control the compression unit so that a size of compressed data is fitted to a physical storage unit of the storage media.

10. The data storage device of claim 9, wherein the controller varies the compression unit according to a compression characteristic of data to be stored in the storage media, and a size of compressed data corresponding to the compression unit is constant.

11. The data storage device of claim 10, wherein the controller comprises:
a central processing unit (CPU);
a buffer to operate according to the control of the CPU and to store data; and
a compression block to operate according to the control of the CPU and to compress data that is sequentially transferred from the buffer by the compression unit.

12. The data storage device of claim 11, wherein a memory translation layer operated by the CPU controls the compression unit variably according to whether a size of data compressed by the compression block satisfies a reference condition.

13. The data storage device of claim 11, wherein the controller further comprises:
a pattern detecting block to predict a compression rate according to data transferred to the buffer.

14. The data storage device of claim 13, wherein a memory translation layer operated by the CPU determines the compression unit according to the predicted compression rate, and controls the compression unit variably according to whether a size of data compressed by the determined compression unit satisfies a reference condition.

15. The data storage device of claim 11, wherein the controller selectively activates the compression block according to data to be stored in the storage media, and data received upon inactivation of the compression block is stored in the storage media via the buffer.

16. The data storage device of claim 9, wherein the storage media comprises:
at least one non-volatile memory, and the physical storage unit corresponds to one of a word, a page, a sector, a block, and a super-block of the at least one non-volatile memory.

17. The data storage device of claim 9, wherein the storage media and the controller constitute a solid state drive.

18. A system comprising:
a plurality of solid state drives,
wherein each of the plurality of solid state drives include a storage media, and a controller to compress data to be stored in the storage media, the controller to compress data to be stored in the storage media by a compression unit and to control the compression unit variably according to a compression characteristic of data to be stored so as to constantly maintain a size of data compressed by the compression unit.

19. The system of claim 18, wherein the storage media comprises:
at least one non-volatile memory, and a size of compressed data corresponding to the compression unit corresponds to one of a word, a page, a sector, a block, and a super-block of the at least one nonvolatile memory.

20. The system of claim 18, further comprising:
a server to provide data to one or mare devices communicatively coupled to the server that request the data.

21-27. (canceled)
